(19) United States
(12) Patent Application Publication
(10) Pub. No.: US 2015/0023359 A1
(43) Pub. Date: Jan. 22, 2015

(54) EDGE EXTENSION OF AN ETHERNET FABRIC SWITCH

(71) Applicant: BROCADE COMMUNICATIONS SYSTEMS, INC., San Jose, CA (US)

(72) Inventors: Tejas Bhandare, Fremont, CA (US); Saurabh Mohan, Sunnyvale, CA (US); Muhammad Durrani, Sunnyvale, CA (US)

(21) Appl. No.: 14/329,447

(22) Filed: Jul. 11, 2014

Related U.S. Application Data
(60) Provisional application No. 61/856,293, filed on Jul. 19, 2013.

(51) Int. Cl. H04L 12/935; H04L 12/933

(52) U.S. Cl. CPC H04L 49/3045; H04L 49/3027; H04L 49/3018; H04L 49/10
USPC 370/401

(57) ABSTRACT

An apparatus, in one embodiment, includes an edge adaptor module, a storage device, and an encapsulation module. The edge adaptor module maintains a membership in a fabric switch. A fabric switch includes a plurality of switches and operates as a single switch. The storage device stores a first table comprising a first mapping between a first edge identifier and a switch identifier. The first edge identifier is associated with the edge adaptor module and the switch identifier is associated with a local switch. This local switch is a member of the fabric switch. The storage device also stores a second table comprising a second mapping between the first edge identifier and a media access control (MAC) address of a local device. During operation, the encapsulation module encapsulates a packet in a fabric encapsulation with the first edge identifier as the ingress switch identifier of the encapsulation header.

### RELATED APPLICATION

This application claims the benefit of U.S. Provisional Application No. 61/856,293, Attorney Docket Number BRCD-3224.0.1.US.PSP, titled “Edge Extension of Ethernet Fabric Switch,” by inventors Tejas Bhandare, Saurabh Mohan, and Muhammad Durrani, filed 19 Jul. 2013, the disclosure of which is incorporated by reference herein.

The present disclosure is related to U.S. patent application Ser. No. 13/087,239, Attorney Docket Number BRCD-3008.1.US.NP, titled “Virtual Cluster Switching,” by inventors Suresh Vobbilisetty and Dilip Chatwani, filed 14 Apr. 2011, the disclosure of which is incorporated by reference herein.

### BACKGROUND

1. Field

The present disclosure relates to network design. More specifically, the present disclosure relates to a method for a constructing a scalable switching system that facilitates automatic configuration.

2. Related Art

The exponential growth of the Internet has made it a popular delivery medium for a variety of applications running on physical and virtual devices. Such applications have brought with them an increasing demand for bandwidth. As a result, equipment vendors race to build larger and faster switches with versatile capabilities. However, the size of a switch cannot grow infinitely. It is limited by physical space, power consumption, and design complexity, to name a few factors. Furthermore, switches with higher capability are usually more complex and expensive. More importantly, because an overly large and complex system often does not provide economy of scale, simply increasing the size and capability of a switch may prove economically unviable due to the increased per-port cost.

A flexible way to improve the scalability of a switch system is to build a fabric switch. A fabric switch is a collection of individual member switches. These member switches form a single, logical switch that can have an arbitrary number of ports and an arbitrary topology. As demands grow, customers can adopt a “pay as you grow” approach to scale up the capacity of the fabric switch.

Meanwhile, layer-2 (e.g., Ethernet) switching technologies continue to evolve. More routing-like functionalities, which have traditionally been the characteristics of layer-3 (e.g., Internet Protocol or IP) networks, are migrating into layer-2. Notably, the recent development of the Transparent Interconnection of Lots of Links (TRILL) protocol allows Ethernet switches to function more like routing devices. TRILL overcomes the inherent inefficiency of the conventional spanning tree protocol, which forces layer-2 switches to be coupled in a logical spanning-tree topology to avoid looping. TRILL allows routing bridges (RBridges) to be coupled in an arbitrary topology without the risk of looping by implementing routing functions in switches and including a hop count in the TRILL header.

While a fabric switch brings many desirable features to a network, some issues remain unsolved in efficiently coupling a large number of end devices (e.g., virtual machines) to the fabric switch.

### SUMMARY

One embodiment of the present invention provides an apparatus. The apparatus includes an edge adaptor module, a storage device, and an encapsulation module. The edge adaptor module maintains a membership in a fabric switch. A fabric switch includes a plurality of switches and operates as a single switch. The storage device stores a first table comprising a first mapping between a first edge identifier and a switch identifier. The first edge identifier is associated with the edge adaptor module and the switch identifier is associated with a local switch. This local switch is a member of the fabric switch. The storage device also stores a second table comprising a second mapping between the first edge identifier and a media access control (MAC) address of a local device. During operation, the encapsulation module encapsulates a packet in a fabric encapsulation with the first edge identifier as the ingress switch identifier of the encapsulation header. This fabric encapsulation is associated with the fabric switch.

In a variation on this embodiment, the first table is stored in a respective member switch of the fabric switch.

In a variation on this embodiment, the apparatus also includes a learning module which updates the second table with a third mapping between a second edge identifier and a second MAC address of a second device. The second edge identifier is associated with a remote second edge adaptor module and the second device is local to the second edge adaptor module.

In a further variation, the update to the second table is in response to one of: (i) identifying the third mapping in a notification message from the second edge adaptor module; and (ii) identifying the second edge identifier as an ingress switch identifier in a fabric encapsulation header, and identifying the second MAC address as a source MAC address in an inner packet.

In a variation on this embodiment, the apparatus also includes a forwarding module which identifies the switch identifier from the first mapping in the first table based on the first edge identifier and identifies a MAC address of the switch associated with the switch identifier. The encapsulation module then sets the MAC address of the switch as a next-hop MAC address for the packet.

In a variation on this embodiment, the apparatus also includes an identifier module which assigns the edge identifier to the edge adaptor module in response to obtaining the edge identifier from the switch.

In a variation on this embodiment, the apparatus is a Network Interface Card (NIC).

One embodiment of the present invention provides a switch. The switch includes a fabric switch module, a storage device, and a forwarding module. The fabric switch module maintains a membership in a fabric switch. A fabric switch includes a plurality of switches and operates as a single switch. The storage device stores a first table comprising a first mapping between a first edge identifier and a switch identifier. The first edge identifier is associated with a local fabric edge adaptor and the switch identifier is associated with a second switch. During operation, the forwarding module, in response to identifying the first edge identifier as an egress switch identifier in a packet, identifies an egress port for the packet. This egress port is associated with a shortest path to the second switch.

In a variation on this embodiment, the fabric switch module allocates the first edge identifier to the fabric edge adaptor.

### BRIEF DESCRIPTION OF THE FIGURES

FIG. 1A illustrates an exemplary fabric switch with fabric edge adaptor support, in accordance with an embodiment of the present invention.

FIG. 1B illustrates an exemplary fabric edge adaptor in a hypervisor in a host machine, in accordance with an embodiment of the present invention.

FIG. 1C illustrates an exemplary fabric edge adaptor in a network interface card (NIC) of a host machine, in accordance with an embodiment of the present invention.

FIG. 1D illustrates an exemplary fabric edge adaptor in a virtual network device in a host machine, in accordance with an embodiment of the present invention.

FIG. 1E illustrates exemplary fabric edge adaptors in member switches of a fabric switch, in accordance with an embodiment of the present invention.

FIG. 2A illustrates an exemplary fabric edge table in a fabric switch, in accordance with an embodiment of the present invention.

FIG. 2B illustrates an exemplary edge Media Access Control (MAC) table in a fabric edge adaptor, in accordance with an embodiment of the present invention.

FIG. 3A presents a flowchart illustrating the process of a fabric edge adaptor discovering an unknown destination, in accordance with an embodiment of the present invention.

FIG. 3B presents a flowchart illustrating the process of a fabric edge adaptor responding to unknown destination discovery, in accordance with an embodiment of the present invention.

FIG. 4A presents a flowchart illustrating the process of a fabric edge adaptor forwarding a packet received from a local device, in accordance with an embodiment of the present invention.

FIG. 4B presents a flowchart illustrating the process of a fabric core node forwarding a packet received from a fabric edge adaptor, in accordance with an embodiment of the present invention.

FIG. 5 illustrates an exemplary computing system and an exemplary switch with fabric edge adaptor support, in accordance with an embodiment of the present invention.

In the figures, like reference numerals refer to the same figure elements.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

### Overview

In embodiments of the present invention, the problem of efficiently coupling a large number of end devices (e.g., physical or virtual machines (VMs)) to a fabric switch is solved by incorporating host machines into the fabric switch. These host machines become member of the fabric switch by running fabric edge adaptors (FEAs). These fabric edge adaptors operate as members of the fabric switch. In this way, the fabric switch is extended to the host machines.

With existing technologies, a fabric switch includes a plurality of member switches coupled to each other via inter-switch ports. The member switches of the fabric switch couple end devices (e.g., a host machine, which is a computing device hosting one or more virtual machines) via edge ports. When a member switch receives a packet via the edge port, the member switch learns the Media Access Control (MAC) address from the packet and maps the edge port with the learned MAC address. The member switch then constructs a notification message, includes the mapping in the notification message, and sends the notification message to other member switches. In this way, a respective member switch is aware of a respective MAC address learned from an edge port of the fabric switch.

With server virtualization, an end device can be a host machine and host a plurality of virtual machines, each of which can have one or more MAC addresses. For example, a host machine can include a hypervisor which runs a plurality of virtual machines. As a result, a member switch can learn a large number of MAC addresses from its respective edge ports. Additionally, the member switch also learns the MAC addresses learned at other member switches. This can make MAC address learning un-scalable for the fabric switch (e.g., may cause a MAC address explosion).

To solve this problem, the fabric switch can be extended to the host machines (i.e., the host machine can be incorporated into the fabric switch). These host machines include fabric edge adaptors. The fabric edge adaptors operate as members of the fabric switch. For example, fabric edge adaptors can encapsulate packets using the fabric encapsulation. These fabric edge adaptors then become the fabric edge nodes of the fabric switch. The other member switches of the fabric switch become the fabric core nodes. In this disclosure, the terms “member switch” and “fabric core node” are used interchangeably. A fabric edge adaptor can reside in the hypervisor or the NIC of the host machine. The fabric edge adaptor can also be in a virtual network device, which is logically coupled to the hypervisor, running on the host machine. A respective member switch of the fabric switch is aware of the fabric core nodes to which the fabric edge adaptors are coupled to. This allows the fabric core nodes to route packets received from fabric edge adaptors.

Since a fabric edge adaptor can reside in a host machine, the fabric edge adaptor receives a packet from a virtual machine in that host machine. The fabric edge adaptor, in turn, encapsulates the packet in fabric encapsulation and forwards the fabric-encapsulated packet to the fabric core nodes of the fabric switch. As a result, the fabric core nodes simply forward the packet based on the fabric encapsulation without learning the MAC address of the virtual machine in the host machine. In this way, in a fabric switch, the fabric edge adaptors learn MAC addresses and the fabric core nodes of the fabric switch forwards the packets without learning the MAC addresses.

In a fabric switch, any number of switches coupled in an arbitrary topology may logically operate as a single switch. The fabric switch can be an Ethernet fabric switch or a virtual cluster switch (VCS), which can operate as a single Ethernet switch. Any member switch may join or leave the fabric switch in “plug-and-play” mode without any manual configuration. In some embodiments, a respective switch in the fabric switch is a Transparent Interconnection of Lots of Links (TRILL) routing bridge (RBridge). In some further embodiments, a respective switch in the fabric switch is an Internet Protocol (IP) routing-capable switch (e.g., an IP router).

It should be noted that a fabric switch is not the same as conventional switch stacking. In switch stacking, multiple switches are interconnected at a common location (often within the same rack), based on a particular topology, and manually configured in a particular way. These stacked switches typically share a common address, e.g., an IP address, so they can be addressed as a single switch externally. Furthermore, switch stacking requires a significant amount of manual configuration of the ports and inter-switch links. The need for manual configuration prohibits switch stacking from being a viable option in building a large-scale switching system. The topology restriction imposed by switch stacking also limits the number of switches that can be stacked. This is because it is very difficult, if not impossible, to design a stack topology that allows the overall switch bandwidth to scale adequately with the number of switch units.

In contrast, a fabric switch can include an arbitrary number of switches with individual addresses, can be based on an arbitrary topology, and does not require extensive manual configuration. The switches can reside in the same location, or be distributed over different locations. These features overcome the inherent limitations of switch stacking and make it possible to build a large “switch farm,” which can be treated as a single, logical switch. Due to the automatic configuration capabilities of the fabric switch, an individual physical switch can dynamically join or leave the fabric switch without disrupting services to the rest of the network.

Furthermore, the automatic and dynamic configurability of the fabric switch allows a network operator to build its switching system in a distributed and “pay-as-you-grow” fashion without sacrificing scalability. The fabric switch's ability to respond to changing network conditions makes it an ideal solution in a virtual computing environment, where network loads often change with time.

In this disclosure, the term “fabric switch” refers to a number of interconnected physical switches which form a single, scalable logical switch. These physical switches are referred to as member switches of the fabric switch. In a fabric switch, any number of switches can be connected in an arbitrary topology, and the entire group of switches functions together as one single, logical switch. This feature makes it possible to use many smaller, inexpensive switches to construct a large fabric switch, which can be viewed as a single logical switch externally. Although the present disclosure is presented using examples based on a fabric switch, embodiments of the present invention are not limited to a fabric switch. Embodiments of the present invention are relevant to any computing device that includes a plurality of devices operating as a single device.

The term “end device” can refer to any device external to a fabric switch. Examples of an end device include, but are not limited to, a host machine, a conventional layer-2 switch, a layer-3 router, or any other type of network device. Additionally, an end device can be coupled to other switches or hosts further away from a layer-2 or layer-3 network. An end device can also be an aggregation point for a number of network devices to enter the fabric switch. An end device hosting one or more virtual machines can be referred to as a host machine. In this disclosure, the terms “end device” and “host machine” are used interchangeably.

The term “switch” is used in a generic sense, and it can refer to any standalone or fabric switch operating in any network layer. “Switch” should not be interpreted as limiting embodiments of the present invention to layer-2 networks. Any device that can forward traffic to an external device or another switch can be referred to as a “switch.” Any physical or virtual device (e.g., a virtual machine/switch operating on a computing device) that can forward traffic to an end device can be referred to as a “switch.” Examples of a “switch” include, but are not limited to, a layer-2 switch, a layer-3 router, a TRILL RBridge, or a fabric switch comprising a plurality of similar or heterogeneous smaller physical and/or virtual switches.

The term “edge port” refers to a port on a fabric switch which exchanges data frames with a network device outside of the fabric switch (i.e., an edge port is not used for exchanging data frames with another member switch of a fabric switch). The term “inter-switch port” refers to a port which sends/receives data frames among member switches of a fabric switch. The terms “interface” and “port” are used interchangeably.

The term “switch identifier” refers to a group of bits that can be used to identify a switch. Examples of a switch identifier include, but are not limited to, a media access control (MAC) address, an Internet Protocol (IP) address, and an RBridge identifier. Note that the TRILL standard uses “RBridge ID” (RBridge identifier) to denote a 48-bit intermediate-system-to-intermediate-system (IS-IS) System ID assigned to an RBridge, and “RBridge nickname” to denote a 16-bit value that serves as an abbreviation for the “RBridge ID.” In this disclosure, “switch identifier” is used as a generic term, is not limited to any bit format, and can refer to any format that can identify a switch. The term “RBridge identifier” is also used in a generic sense, is not limited to any bit format, and can refer to “RBridge ID,” “RBridge nickname,” or any other format that can identify an RBridge.

The term “packet” refers to a group of bits that can be transported together across a network. “Packet” should not be interpreted as limiting embodiments of the present invention to layer-3 networks. “Packet” can be replaced by other terminologies referring to a group of bits, such as “message,” “frame,” “cell,” or “datagram.”

### Network Architecture

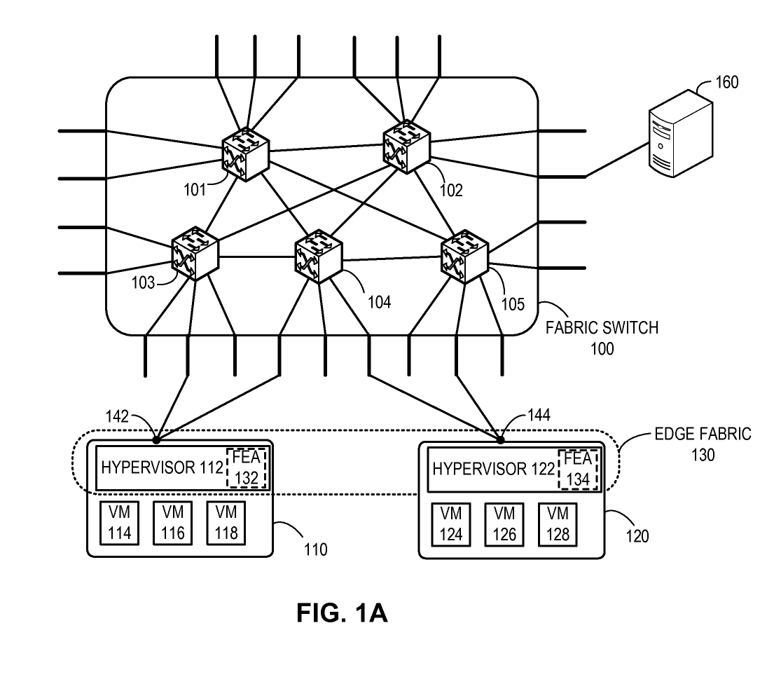

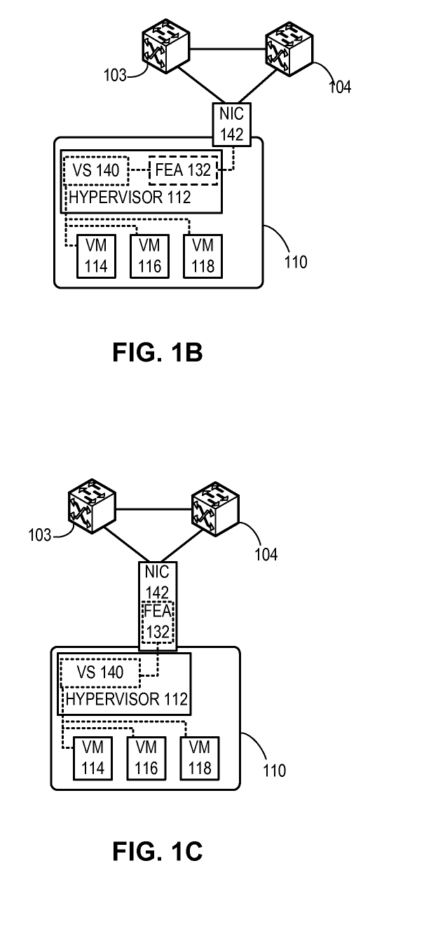

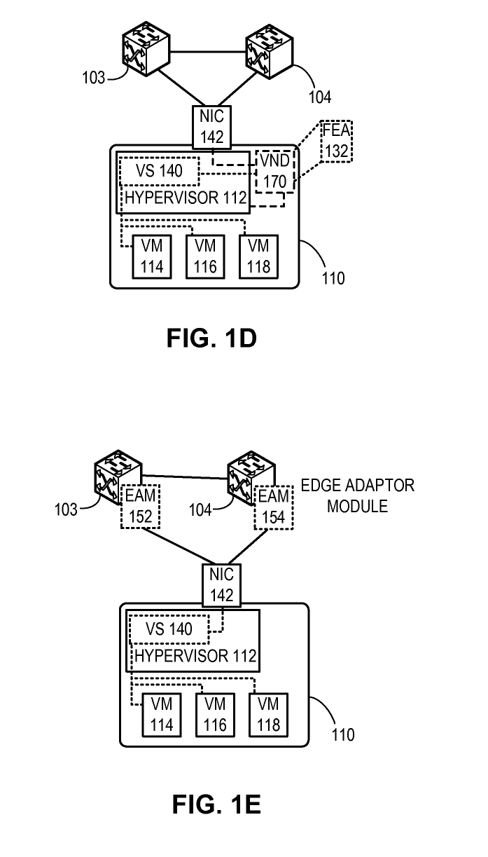

FIG. 1A illustrates an exemplary fabric switch with fabric edge adaptor support, in accordance with an embodiment of the present invention. As illustrated in FIG. 1A, a fabric switch 100 includes member switches 101, 102, 103, 104, and 105. End device 110 is coupled to switches 103 and 104, end device 120 is coupled to switches 104 and 105, and end device 160 is coupled to switch 102. In some embodiments, fabric switch 100 is a TRILL network and a respective member switch of fabric switch 100, such as switch 105, is a TRILL RBridge. In some further embodiments, fabric switch 100 is an IP network and a respective member switch of fabric switch 100, such as switch 105, is an IP-capable switch, which calculates and maintains a local IP routing table (e.g., a routing information base or RIB), and is capable of forwarding packets based on its IP addresses.

In some embodiments, fabric switch 100 is assigned with a fabric switch identifier. A respective member switch of fabric switch 100 is associated with that fabric switch identifier. This allows the member switch to indicate that it is a member of fabric switch 100. In some embodiments, whenever a new member switch joins fabric switch 100, the fabric switch identifier is automatically associated with that new member switch. Furthermore, a respective member switch of fabric switch 100 is assigned a switch identifier (e.g., an RBridge identifier, a Fibre Channel (FC) domain ID (identifier), or an IP address). This switch identifier identifies the member switch in fabric switch 100.

In some embodiments, end devices 110 and 120 are host machines, each hosting one or more virtual machines. Host machine 110 includes a hypervisor 112 which runs virtual machines 114, 116, and 118. Host machine 110 can be equipped with a Network Interface Card (NIC) 142 with one or more ports. Host machine 110 couples to switches 103 and 104 via the ports of NIC 142. Similarly, host machine 120 includes a hypervisor 122 which runs virtual machines 124, 126, and 128. Host machine 120 can be equipped with a NIC 144 with one or more ports. Host machine 120 couples to switches 103 and 104 via the ports of NIC 144.

Switches in fabric switch 100 use edge ports to communicate with end devices (e.g., non-member switches) and inter-switch ports to communicate with other member switches. For example, switch 102 is coupled to end device 160 via an edge port and to switches 101, 103, 104, and 105 via inter-switch ports and one or more links. Data communication via an edge port can be based on Ethernet and via an inter-switch port can be based on IP and/or TRILL protocol. It should be noted that control message exchange via inter-switch ports can be based on a different protocol (e.g., Internet Protocol (IP) or Fibre Channel (FC) protocol).

With server virtualization, host machines 110 and 120 host a plurality of virtual machines, each of which can have one or more MAC addresses. For example, host machine 110 includes hypervisor 112 which runs a plurality of virtual machines 114, 116, and 118. As a result, switch 103 can learn a large number of MAC addresses belonging to virtual machines 114, 116, and 118 from the edge port coupling end device 110. Furthermore, switch 103 also learns a large number of MAC addresses belonging to virtual machines 124, 126, and 128 learned at switches 104 and 105 based on reachability information sharing among member switches. In this way, having a large number of virtual machines coupled to fabric switch 100 may make MAC address learning un-scalable for fabric switch 100 and cause a MAC address explosion.

To solve this problem, fabric switch 100 can be extended to host machines 110 and 120. Host machines 110 and 120 include fabric edge adaptors 132 and 134, respectively. Fabric edge adaptor 132 or 134 can operate as member switches of fabric switch 100. This extension can be referred to as edge fabric 130. In some embodiments, fabric edge adaptor 132 or 134 is a virtual module capable of operating as a switch and encapsulating a packet from a local device (e.g., a virtual machine) in a fabric encapsulation. Fabric edge adaptors 132 and 134 are assigned (e.g., either configured with or automatically assigned by fabric switch 100) respective edge identifiers. In some embodiments, an edge identifier is in the same format as a switch identifier assigned to a member switch of fabric switch 100. For example, if the switch identifier is an RBridge identifier, the edge identifier can be in the format of an RBridge identifier.

In some embodiments, fabric edge adaptor 132 and 134 reside in hypervisors 112 and 122, respectively. Fabric edge adaptor 132 and 134 can also reside in NICs 142 and 144, respectively, or in an additional virtual network device logically coupled to hypervisors 112 and 122, respectively. Fabric edge adaptors 132 and 134 can also be in one or more switches in fabric switch 100. It should be noted that fabric edge adaptors 132 and 134 can reside in different types of devices. For example, fabric edge adaptor 132 can be in hypervisor 112 and fabric edge adaptor 134 can be in NIC 144. As a result, fabric switch 100 can include a heterogeneous implementations of fabric edge adaptors.

A respective member switch of fabric switch 100 can maintain a fabric edge table which maps the switch identifier of a fabric core node to the edge identifiers of the fabric edge adaptors coupled to the fabric core node. If there is no edge identifier mapped to the switch identifier, it implies that there is no fabric edge adaptor coupled to that fabric core node. The fabric edge table is distributed across fabric switch 100 (i.e., a respective member of fabric switch 100 has the same fabric edge table).

In some embodiments, the fabric edge table is populated when edge identifiers of the fabric edge adaptors are assigned by fabric switch 100. Suppose that switch 103 assigns an edge identifier to fabric edge adaptor 132. Switch 103 creates a mapping between the switch identifier of switch 103 and edge adaptor 132, and shares this information with other member switches (e.g., using a notification message). In some embodiments, switch 103 uses a name service of fabric switch 100 to share this information. Since switch 103 is coupled to fabric edge adaptor 132, the fabric edge table of fabric switch 100 includes a mapping between the switch identifier of switch 103 and the edge identifier of fabric edge adaptor 132. The fabric edge table of fabric switch 100 also includes a mapping between the switch identifier of switch 104 and the edge identifiers of fabric edge adaptors 132 and 134, and a mapping between the switch identifier of switch 105 and the edge identifier of fabric edge adaptor 134. The fabric edge table allows the fabric core nodes of fabric switch 100 to route packets to and from fabric edge adaptors.

Because fabric edge adaptors 132 and 134 can operate as member switches of fabric switch 100, the links coupling host machines 110 and 120 can operate as inter-switch links (i.e., the ports in NICs 142 and 144 can operate as inter-switch ports). In some embodiments, fabric edge adaptors 132 and 134 use a link discovery protocol (e.g., Brocade Link Discovery Protocol (BLDP)) to allow fabric switch 100 to discover fabric edge adaptors 132 and 134 as nodes in edge fabric 130. When fabric edge adaptor 132 becomes active, fabric edge adaptor 132 can use BLDP to notify fabric switch 100. Switch 103 or 104 can send a notification message comprising an edge identifier for fabric edge adaptor 132. In turn, fabric edge adaptor 132 can self-assign the edge identifier. Switches 101-105 can forward packets to fabric edge adaptors 132 and 134 based on their edge identifiers using the routing and forwarding techniques of fabric switch 100. For example, switch 101 has two equal-cost paths (e.g., Equal Cost Multiple Paths or ECMP) to fabric edge adaptor 132 via switches 103 and 104.

Using these multiple paths, switch 101 can load balance among the paths to fabric edge adaptor 132. In the same way, switch 101 can load balance among the paths to fabric edge adaptor 134 via switches 104 and 105. By consulting the fabric edge table, switch 101 can determine that fabric edge adaptor 132 is coupled to switches 103 and 104. Switch 101 uses the routing protocol used in fabric switch 100 (e.g., Fabric Shortest Path First (FSPF)) to calculate routes to switches 103 and 104. Switch 101 can then forward packets destined to fabric edge adaptor 132 to switch 103 or 104 via the shortest path. If TRILL is used for forwarding among the member switches of fabric switch 100, switch 101 can use TRILL to forward packets to fabric edge adaptor 132 based on the calculated shortest paths. In this way, fabric switch 100 is extended to host machines 110 and 120.

Furthermore, if one of the paths become unavailable (e.g., due to a link or node failure), switch 101 can still forward packets via the other path. Suppose that switch 103 becomes unavailable (e.g., due to a node failure or a reboot). As a result, the path from switch 101 to fabric edge adaptor 132 via switch 103 becomes unavailable as well. Upon detecting the failure, switch 101 can forward packets to fabric edge adaptor 132 via switch 104. Routing, forwarding, and failure recovery of a fabric switch is specified in U.S. patent application Ser. No. 13/087,239, Attorney Docket Number BRCD-3008.1.US.NP, titled “Virtual Cluster Switching,” by inventors Suresh Vobbilisetty and Dilip Chatwani, filed 14 Apr. 2011, the disclosure of which is incorporated herein in its entirety.

Fabric edge adaptors 132 maintains an edge MAC table which includes mappings between the edge identifier of fabric edge adaptor 132 and MAC addresses of virtual machines 114, 116, and 118. In some embodiments, edge MAC table is pre-populated with these mapping (i.e., not based on MAC learning, rather configured or provided) in fabric edge adaptor 132. As a result, when fabric edge adaptor 132 becomes active, these mappings are available in its local edge MAC table. Similarly, fabric edge adaptors 134 maintains an edge MAC table which includes pre-populated mappings between the edge identifier of fabric edge adaptor 134 and MAC addresses of virtual machines 124, 126, and 128.

During operation, virtual machine 114 sends a packet to virtual machine 124. Since fabric edge adaptor 132 resides in hypervisor 112, fabric edge adaptor 132 receives the packet, encapsulates the packet in a fabric encapsulation (e.g., TRILL or IP), and forwards the fabric-encapsulated packet to switch 103. Fabric edge adaptor 132 can use its edge identifier as the ingress switch identifier of the encapsulation header. If the destination is unknown, fabric edge adaptor 132 can use the multicast distribution tree of fabric switch 100 to forward the packet. Fabric edge adaptor 132 uses an “all switch” identifier corresponding to a respective switch in fabric switch as the egress switch identifier of the encapsulation header and forwards the packet to switch 103 (or 104). Upon receiving the packet, switch 103 can forward the packet based on the fabric encapsulation without learning the MAC address of virtual machine 114. In this way, in fabric switch 100, fabric edge adaptors learn MAC addresses and the fabric core nodes of the fabric switch forwards the packets without learning a respective MAC address learned via the edge ports of the fabric switch.

When this fabric-encapsulated packet reaches the root switch of the multicast distribution tree of fabric switch 100, the root switch forwards the fabric-encapsulated packet to all members (i.e., fabric core and edge nodes) of fabric switch 100. In some embodiments, the root switch does not forward to the originating node (i.e., fabric edge adaptor 132). When the packet reaches fabric edge adaptor 134, it consults its local edge MAC table and identifies the MAC address of virtual machine 124 in the local edge MAC table. Fabric edge adaptor decapsulates the packet from fabric encapsulation and forwards the inner packet to virtual machine 124. Fabric edge adaptor 134 learns the MAC address of virtual machine 114 and its association with fabric edge adaptor 132 from the packet, and updates its local edge MAC table with a mapping between fabric edge adaptor 132 and the MAC address of virtual machine 114.

In some embodiments, fabric edge adaptor 134 sends a fabric-encapsulated notification message to fabric edge adaptor 132 comprising a mapping between fabric edge adaptor 134 and the MAC address of destination virtual machine 124. In this way, fabric edge adaptors 132 and 134 only learn the MAC addresses used in communication. For example, if no packet is sent from virtual machine 128, fabric edge adaptor 132 does not learn the MAC address of virtual machine 128. It should be noted that edge MAC tables in fabric edge adaptors 132 and 134 are not shared or synchronized with other members of fabric switch 100. This allows isolation and localization of MAC address learning and prevents MAC address flooding in fabric switch 100.

In some embodiments, when a packet is received from a device which does not include a fabric edge adaptor, the learned MAC address is shared with other members of fabric switch 100. For example, if switch 102 receives a packet from end device 160, switch 102 learns the MAC address of end device 160. Switch 102 creates a notification message comprising the learned MAC address and sends the notification message to other fabric core nodes (i.e., switches 101, 103, 104, and 105). Switch 102 can send this notification message to fabric edge adaptors 132 and 134 as well. This provides backward compatibility and allows a device which does not support fabric edge adaptors to operate with fabric switch 100.

In some embodiments, fabric edge adaptors 132 and 134 are associated with respective MAC addresses as well. If forwarding in fabric switch 100 is based on TRILL, a respective member switch is associated with an RBridge identifier and a MAC address. The RBridge identifier is used for end-to-end forwarding and the MAC address is used for hop-by-hop forwarding. A respective member, which can be a member switch or a fabric edge adaptor, can maintain a mapping between the RBridge identifier (or edge identifier) and the corresponding MAC address. The TRILL protocol is described in Internet Engineering Task Force (IETF) Request for Comments (RFC) 6325, titled “Routing Bridges (RBridges): Base Protocol Specification,” available at http://datatracker.ietf.org/doc/rfc6325/, which is incorporated by reference herein.

The MAC addresses of fabric edge adaptors 132 and 134 can be used for hop-by-hop forwarding of TRILL-encapsulated packets to fabric edge adaptors 132 and 134. For example, when switch 103 receives a TRILL-encapsulated packet with the edge identifier of fabric edge adaptor 132 as the egress switch identifier, switch 103 determines from its fabric edge table that fabric edge adaptor 132 is locally coupled. Switch 103 obtains the MAC address of fabric edge adaptor 132 from its mapping with the edge identifier of fabric edge adaptor 132. Switch 103 uses the MAC address of fabric edge adaptor 132 as the outer destination MAC address of the TRILL encapsulation and forwards the TRILL-encapsulated packet to fabric edge adaptor 132.

### Fabric Edge Adaptor

FIG. 1B illustrates an exemplary fabric edge adaptor in a hypervisor in a host machine, in accordance with an embodiment of the present invention. In this example, a virtual switch (VS) 140 is in hypervisor 112. Virtual switch 140 is logically coupled to virtual machine 114, 116, and 118. Fabric edge adaptor 132 is logically coupled to virtual switch 140 and NIC 142. In other words, fabric edge adaptor 132 can reside between virtual switch 140 and NIC 142. As a result, when virtual machine 114 forwards a packet, virtual switch 140 obtains the packet and logically switches the packet to fabric edge adaptor 132. Upon obtaining the packet, fabric edge adaptor 132 encapsulates the packet in fabric encapsulation with its identifier as the ingress switch identifier of the encapsulation header. Fabric edge adaptor 132 then forwards the fabric-encapsulated packet via NIC 142.

FIG. 1C illustrates an exemplary fabric edge adaptor in a NIC of a host machine, in accordance with an embodiment of the present invention. In this example, fabric edge adaptor 132 resides in NIC 142. Fabric edge adaptor 132 can be a physical or logical module of NIC 142. Virtual switch 140 in hypervisor 112 can be logically coupled to fabric edge adaptor 132. This allows fabric edge adaptor 132 to reside between virtual switch 140 and the forwarding circuitry of NIC 142. As a result, when virtual machine 114 sends a packet, virtual switch 140 obtains the packet and logically switches the packet to fabric edge adaptor 132. Upon obtaining the packet, fabric edge adaptor 132 encapsulates the packet in fabric encapsulation with its identifier as the ingress switch identifier of the encapsulation header. Fabric edge adaptor 132 then forwards the fabric-encapsulated packet via the forwarding circuitry of NIC 142.

FIG. 1D illustrates an exemplary fabric edge adaptor in a virtual network device in a host machine, in accordance with an embodiment of the present invention. In this example, host machine 110 includes a virtual network device (VND) 170. Virtual network device 170 can be any a virtual device capable of forwarding packets. Fabric edge adaptor 132 can reside in virtual network device 170. Fabric edge adaptor 132 can be a logical module in virtual network device 170. By including virtual network device 170 in host machine 110, edge fabric 130 can be extended to host machine 110 without any modification to hypervisor 112 or NIC 142.

Virtual switch 140 in hypervisor 112 can be logically coupled to virtual network device 170. This allows fabric edge adaptor 132 to reside between virtual switch 140 and NIC 142. As a result, when virtual machine 114 forwards a packet, virtual switch 140 obtains the packet and logically switches the packet to virtual network device 170. Fabric edge adaptor 132 residing in virtual network device 170 obtains this packet, encapsulates the packet in fabric encapsulation with its identifier as the ingress switch identifier of the encapsulation header. Fabric edge adaptor 132 then forwards the fabric-encapsulated packet via NIC 142.

FIG. 1E illustrates exemplary fabric edge adaptors in member switches of a fabric switch, in accordance with an embodiment of the present invention. Fabric edge adaptor 132 can be a physical or virtual edge adaptor module (EAM) in a member switch of fabric switch 100. In this example, fabric edge adaptor 132 can be edge adaptor module 152 in switch 103 and/or edge adaptor module 154 in switch 104. Edge adaptor module 152 or 154 maintains an edge MAC table comprising the MAC addresses of virtual machines 114, 116, and 118. This edge MAC table is not shared with other switches in fabric switch 100. Edge adaptor module 152 or 154 can be associated with the edge identifier of fabric edge adaptor 132. Member switches in fabric switch 100 can maintain a fabric edge table comprising the mapping between the edge identifier and the switch identifiers of switches 103 and/or 104. In this way, edge fabric 130 can be created in the member switches of fabric switch 100 with the separation of edge MAC table, thereby providing scalable MAC address learning to fabric switch 100.

### Mapping Tables

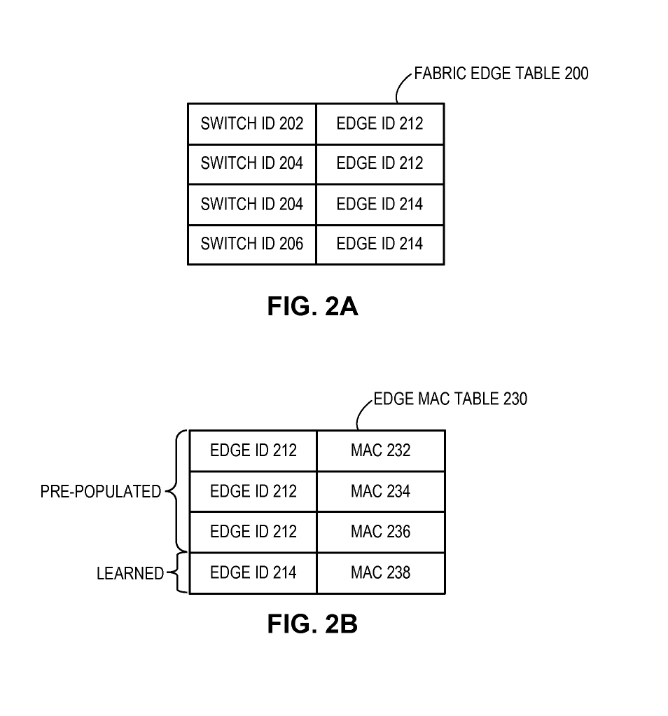

FIG. 2A illustrates an exemplary fabric edge table in a fabric switch, in accordance with an embodiment of the present invention. Suppose that switches 103, 104, and 105 are associated with switch identifiers 202, 204, and 206, respectively, and fabric edge adaptors 132 and 134 are associated with edge identifiers 212 and 214, respectively. A fabric edge table 200 of fabric switch 100 maps switch identifiers of switches 103, 104, and 105 to the edge identifiers of fabric edge adaptors coupled to the corresponding switch. Since switch 103 is coupled to fabric edge adaptor 132, fabric edge table 200 includes a mapping between switch identifier 202 of switch 103 and edge identifier 212 of fabric edge adaptor 132.

Fabric edge table 200 also includes mappings between switch identifier 204 of switch 104 and edge identifiers 212 and 214 of fabric edge adaptors 132 and 134, respectively, and a mapping between switch identifier 206 of switch 105 and edge identifier 214 of fabric edge adaptor 134. If there is no edge identifier mapped to the switch identifier, it implies that there is no fabric edge adaptor coupled to that fabric core node. For example, fabric edge table 200 does not include a mapping for the switch identifiers of switches 101 and 102. This indicates that switch 101 and 102 are not coupled to a fabric edge adaptor. Fabric edge table 200 is distributed across fabric switch 100 (i.e., a respective member of fabric switch 100 has the same fabric edge table).

Fabric edge table 200 allows fabric core nodes of fabric switch 100 to forward packets to fabric edge adaptors 132 and 134. For example, switch 101 also has a local instance of fabric edge table 200. The routing mechanism of fabric switch 100 (e.g., FSPF) allows a respective fabric core node of fabric switch 100 to establish shortest path to all other fabric core nodes. By consulting fabric edge table 200, switch 101 determines that edge identifier 212 is mapped to switch identifiers 202 and 204. Upon receiving a fabric-encapsulated packet with edge identifier 212 as the egress switch identifier of the encapsulation header, switch 101 determines that the packet should be forwarded to switch 103 or 104 (corresponding to switch identifier 202 or 204, respectively). Switch 101 then forwards the packet via the shortest path to switch 103 or 104. In some embodiments, switch 101 can use both paths via switches 103 and 104 to perform load balancing among them.

FIG. 2B illustrates an exemplary edge MAC table in a fabric edge adaptor, in accordance with an embodiment of the present invention. Suppose that virtual machines 114, 116, 118, and 124 are associated with MAC addresses 232, 234, 236, and 238, respectively. Fabric edge adaptors 132 maintains an edge MAC table 230 which includes mappings between edge identifier 212 of fabric edge adaptor 132 and MAC addresses 232, 234, and 234 of virtual machines 114, 116, and 118, respectively. In some embodiments, edge MAC table 230 is pre-populated with these mapping (i.e., not based on MAC learning, rather configured or provided) in fabric edge adaptor 132. As a result, when fabric edge adaptor 132 becomes active, these mappings are available in edge MAC table 230.

Fabric edge adaptors 134 maintains a similar edge MAC table which includes pre-populated mappings between the edge identifier of fabric edge adaptor 134 and MAC addresses of virtual machines 124, 126, and 128. Suppose that fabric edge adaptor 134 receives a fabric-encapsulated packet with an “all switch” identifier as the egress switch identifier. If this packet includes an inner packet with MAC address 238 as the destination MAC address, fabric edge adaptor 134 determines that MAC address 238 is in the local edge MAC table. Fabric edge adaptor 134 then notifies fabric edge adaptor 132 using a notification message comprising a mapping between edge identifier 214 and MAC address 238.

Upon receiving the notification message, fabric edge adaptor 132 learns the mapping and updates edge MAC table 230 with the mapping between edge identifier 214 and MAC address 238. In this way, edge MAC table 230 includes both pre-populated and learned MAC addresses. However, the learned MAC addresses in edge MAC table 230 are associated with a communication with fabric edge adaptor 132. For example, if fabric edge adaptor 132 is not in communication with virtual machine 128, edge MAC table 230 does not include the MAC address of virtual machine 128. It should be noted that edge MAC table 230 is local to fabric edge adaptor 132 and is not distributed in fabric switch 100.

### Unknown Destination Discovery

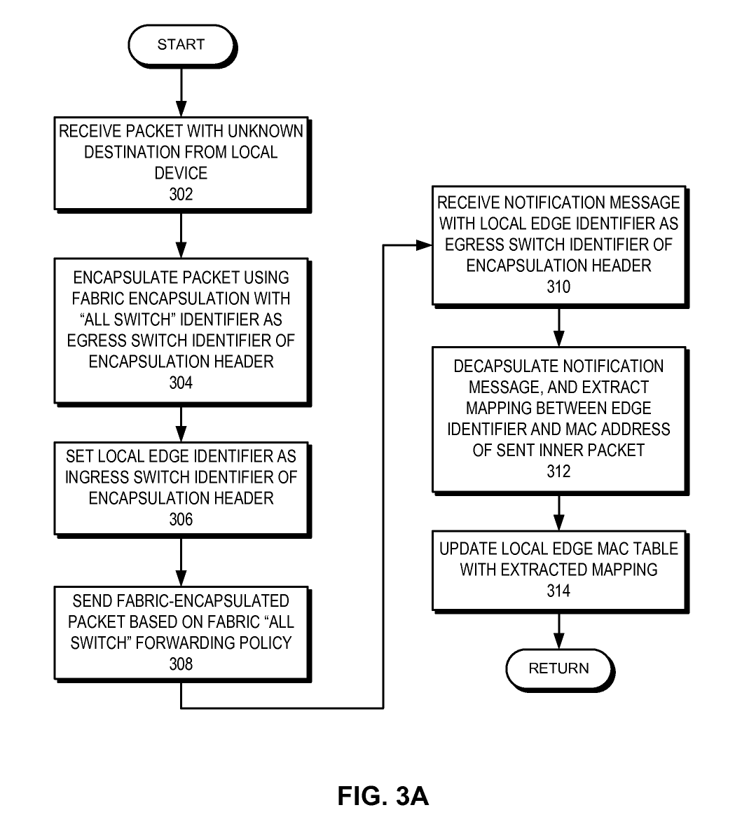

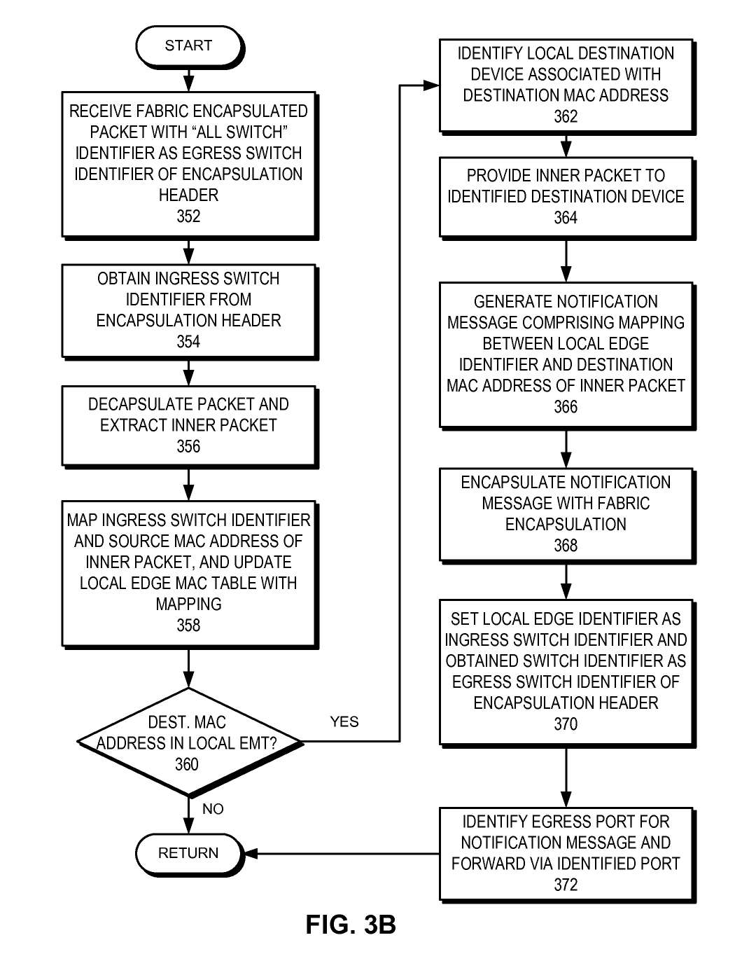

In the example in FIG. 1A, when virtual machine 114 sends a packet to virtual machine 124 and fabric edge adaptor 132 has not learned the MAC address of virtual machine 124, the MAC address of virtual machine 124 is an unknown destination. FIG. 3A presents a flowchart illustrating the process of a fabric edge adaptor discovering an unknown destination, in accordance with an embodiment of the present invention. During operation, the fabric edge adaptor of a fabric switch receives a packet with unknown destination from a local device (e.g., a local virtual machine) (operation 302).

The fabric edge adaptor encapsulates the packet using fabric encapsulation with an “all switch” identifier as the egress switch identifier of the encapsulation header (operation 304). A packet with an all switch identifier as the egress switch identifier is sent to a respective member (which can be a member switch or fabric core node, or a fabric edge adaptor) of the fabric switch. This packet can be sent via the multicast tree of the fabric switch. The fabric edge adaptor sets the local edge identifier as the ingress switch identifier of the encapsulation header (operation 306) and sends the fabric-encapsulated packet based on the fabric “all switch” forwarding policy (operation 308). Examples of a fabric “all switch” forwarding policy include, but are not limited to, forwarding via fabric multicast tree, forwarding via a multicast tree rooted at an egress switch, unicast forwarding to a respective member of the fabric switch, and broadcast forwarding in the fabric switch.

If the unknown destination is coupled to a remote fabric edge adaptor, the fabric edge adaptor can receive a notification message, which is from the destination fabric edge adaptor, with local edge identifier as the egress switch identifier of the encapsulation header (operation 310), as described in conjunction with FIG. 1A. This notification message allows the fabric edge adaptor to learn MAC addresses of the unknown destination. The fabric edge adaptor decapsulates the notification message and extracts a mapping between an edge identifier and the destination MAC address of the send inner packet (i.e., the unknown destination) (operation 312). This edge identifier is associated with the destination fabric edge adaptor. The fabric edge adaptor then updates the local edge MAC table with the extracted mapping (operation 314), as described in conjunction with FIG. 2B.

FIG. 3B presents a flowchart illustrating the process of a fabric edge adaptor responding to unknown destination discovery, in accordance with an embodiment of the present invention. During operation, the fabric edge adaptor of a fabric switch receives a fabric encapsulated packet with an “all switch” identifier as the egress switch identifier of the encapsulation header (operation 252). The fabric edge adaptor obtains the ingress switch identifier from the encapsulation header (operation 354), and decapsulates the packet and extracts the inner packet (operation 356). If the encapsulated packet is from a remote fabric edge adaptor, the ingress switch identifier is an edge identifier. The fabric edge adaptor then maps the ingress switch identifier, which can be an edge identifier, to the source MAC address of the inner packet, and updates the local edge MAC table with the mapping (operation 358).

The fabric edge adaptor checks whether the destination MAC address is in a local edge MAC table (operation 360). If so, the fabric edge adaptor identifies the local destination device (e.g., a virtual machine) associated with the destination MAC address (operation 362) and provides (e.g., logically switches) the inner packet to the identified destination device (operation 364). The fabric edge adaptor then generates a notification message comprising a mapping between the local edge identifier and the destination MAC address of the inner packet (operation 366) and encapsulates the notification message with fabric encapsulation (operation 368). The fabric edge adaptor sets the local edge identifier as the ingress switch identifier and the obtained switch identifier, which can be an edge identifier, as the egress switch identifier of the encapsulation header (operation 370). The fabric edge adaptor identifies an egress port for the notification message and forwards the notification message via the identified port (operation 372).

### Packet Forwarding

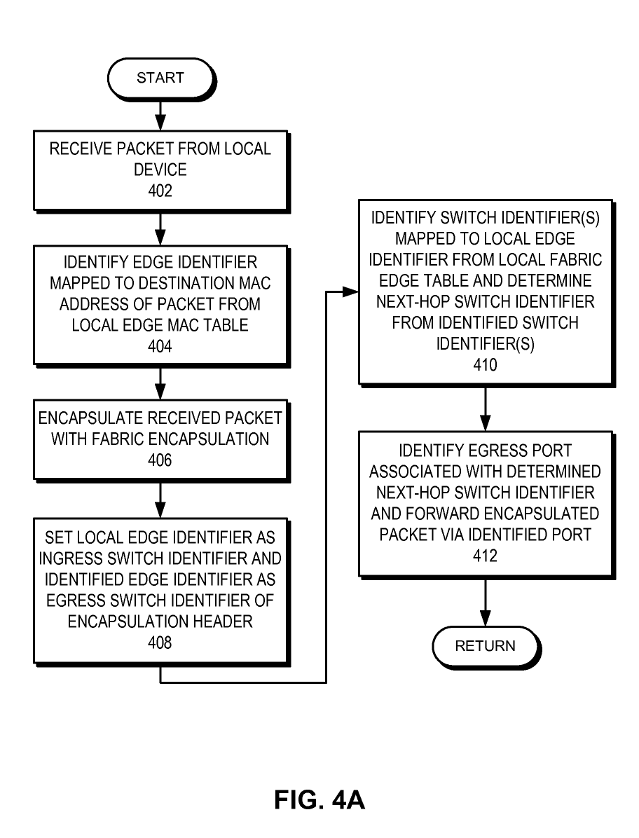

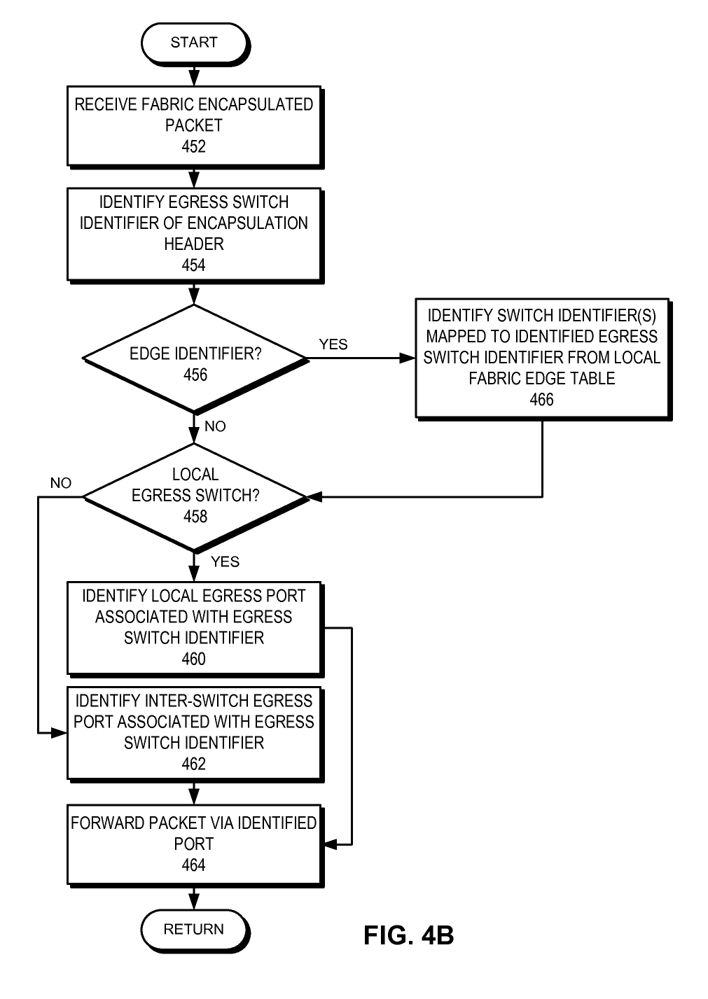

In the example in FIG. 1A, fabric edge adaptor 132 encapsulates and forwards packets received from local virtual machines. Switch 103 or 104 receives the encapsulated packet and forwards the packet based on the encapsulation. FIG. 4A presents a flowchart illustrating the process of a fabric edge adaptor forwarding a packet received from a local device, in accordance with an embodiment of the present invention. During operation, the fabric edge adaptor receives a packet from a local device, which can be a local virtual machine (operation 402). The fabric edge adaptor identifies the edge identifier mapped to the destination MAC address of the packet from a local edge MAC table (operation 404). If the destination MAC address is not in the local edge MAC table, the destination MAC address is an unknown destination, and the packet is forwarded accordingly, as described in conjunction with FIG. 3A. The fabric edge adaptor encapsulates the received packet with fabric encapsulation (operation 406).

The fabric edge adaptor sets the local edge identifier as the ingress switch identifier and the identified edge identifier as egress switch identifier of the encapsulation header (operation 408). The fabric edge adaptor identifies the switch identifier(s) mapped to local edge identifier from a local fabric edge table and determines the next-hop switch identifier from identified switch identifier(s) (operation 410). This selection can be based on a selection policy (e.g., load balancing, security, etc). The fabric edge adaptor then identifies an egress port associated with the determined next-hop switch identifier and forwards the encapsulated packet via the identified port (operation 412). It should be noted that this egress port can be a physical or a virtual port. If the fabric encapsulation is based on TIRLL, the local and identified edge identifiers are in the same format as an RBridge identifier. The fabric edge adaptor can then obtain a MAC address mapped to the next-hop switch identifier and use that MAC address as an outer destination MAC address of TRILL encapsulation.

FIG. 4B presents a flowchart illustrating the process of a fabric core node forwarding a packet received from a fabric edge adaptor, in accordance with an embodiment of the present invention. During operation, the fabric edge adaptor receives a fabric encapsulated packet (operation 452) and identifies the egress switch identifier of the encapsulation header (operation 454). The fabric edge adaptor checks whether the identified egress switch identifier is an edge identifier (operation 456). In some embodiments, the fabric edge adaptor determines a switch identifier to be an edge identifier based on one or more of: a range of identifiers, an identifier prefix, and an identifier suffix.

If the identified egress switch identifier is an edge identifier, the fabric edge adaptor identifies the switch identifier(s) mapped to the identified egress switch identifier from a local fabric edge table (operation 466). If the identified egress switch identifier is not an edge identifier (operation 456) or the switch identifier(s) have been identified (operation 466), the fabric edge adaptor checks whether at least one of the switch identifier(s) indicates the local switch to be the egress switch (operation 458). If the local switch is the egress switch, the fabric edge adaptor identifies a local egress port, which can be a physical or virtual port, associated with the egress switch identifier (operation 460). If the local switch is not the egress switch, the fabric edge adaptor identifies an inter-switch egress port associated with the egress switch identifier (operation 462). It should be noted that if the egress switch identifier is an edge identifier, the inter-switch port is associated with the corresponding switch identifier obtained in operation 466. The fabric edge adaptor then forwards the packet via the identified port (operation 464).

### Exemplary Computing System

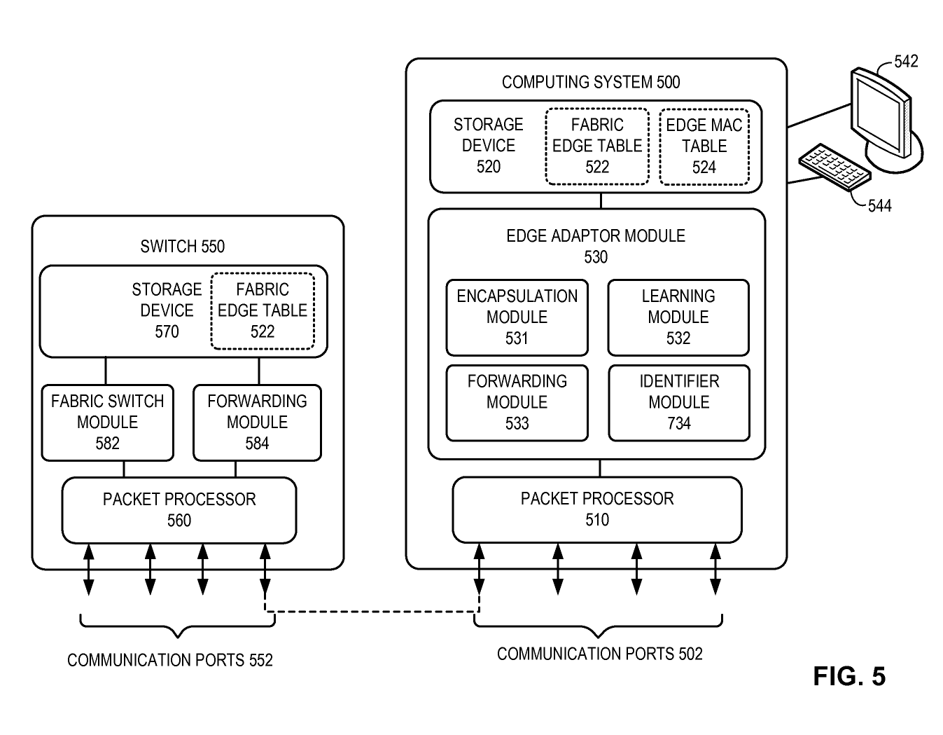

FIG. 5 illustrates an exemplary computing system and an exemplary switch with fabric edge adaptor support, in accordance with an embodiment of the present invention. In this example, a computing system 500 includes a general purpose processor 504, a memory 506, a number of communication ports 502, a packet processor 510, an edge adaptor module 530, an encapsulation module 531, and a storage device 520. In some embodiments, edge adaptor module 530 is in a NIC of computing system 500. Computing system 500 can be coupled to a display device 542 and an input device 544.

Edge adaptor module 530 maintains a membership for edge adaptor module 530 in a fabric switch. Storage device 520 stores a fabric edge table 522 comprising a mapping between an edge identifier and a switch identifier, as described in conjunction with FIG. 2A. The switch identifier is associated with a switch 550 to which computing system 500 is coupled (denoted with dashed lines). Storage device 520 also stores an edge MAC table 524 comprising a mapping between the edge identifier and a MAC address of a local device, as described in conjunction with FIG. 2B. During operation, encapsulation module 531 encapsulates a packet in a fabric encapsulation with the edge identifier as ingress switch identifier of encapsulation header.

In some embodiments, computing system 500 also includes a learning module 532 which updates edge MAC table 524 with a mapping between a learned MAC address and its corresponding edge identifier. Computing system 500 can also include a forwarding module 533, which identifies the switch identifier from the mapping in fabric edge table 522 based on the edge identifier and identifies a MAC address of switch 550 associated with the corresponding switch identifier. Encapsulation module 531 then sets the MAC address of switch 550 as a next-hop MAC address for the packet. In some embodiments, computing system 500 also includes an identifier module 534, which assigns the edge identifier to edge adaptor module 531 in response to obtaining the edge identifier from switch 550.

Switch 550 includes a number of communication ports 552, a packet processor 560, a fabric switch module 582, a forwarding module 584, and a storage device 570. Fabric switch module 582 maintains a membership for switch 550 in the fabric switch. As fabric edge table 522 is distributed across the fabric switch, storage device 570 in switch 550 also stores fabric edge table 522. During operation, forwarding module 584, in response to identifying the edge identifier as an egress switch identifier in a packet, identifies an egress port from communication ports 552 for the packet. In some embodiments, fabric switch module 582 allocates the edge identifier to edge adaptor module 530.

Note that the above-mentioned modules can be implemented in hardware as well as in software. In one embodiment, these modules can be embodied in computer-executable instructions stored in a memory which is coupled to one or more processors in computing device 500 and switch 550. When executed, these instructions cause the processor(s) to perform the aforementioned functions.

In summary, embodiments of the present invention provide an apparatus and a method for extending the edge of a fabric switch. In one embodiment, the apparatus includes an edge adaptor module, a storage device, and an encapsulation module. The edge adaptor module maintains a membership in a fabric switch. A fabric switch includes a plurality of switches and operates as a single switch. The storage device stores a first table comprising a first mapping between a first edge identifier and a switch identifier. The first edge identifier is associated with the edge adaptor module and the switch identifier is associated with a local switch. This local switch is a member of the fabric switch. The storage device also stores a second table comprising a second mapping between the first edge identifier and a media access control (MAC) address of a local device. During operation, the encapsulation module encapsulates a packet in a fabric encapsulation with the first edge identifier as the ingress switch identifier of the encapsulation header. This fabric encapsulation is associated with the fabric switch.

The methods and processes described herein can be embodied as code and/or data, which can be stored in a computer-readable non-transitory storage medium. When a computer system reads and executes the code and/or data stored on the computer-readable non-transitory storage medium, the computer system performs the methods and processes embodied as data structures and code and stored within the medium.

The methods and processes described herein can be executed by and/or included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of embodiments of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. An apparatus, comprising:
an edge adaptor module adapted to maintain a membership in a fabric switch, wherein the fabric switch includes a plurality of switches and operates as a single switch;
a storage device adapted to store:
a first table comprising a first mapping between a first edge identifier and a switch identifier, wherein the first edge identifier is associated with the edge adaptor module, wherein the switch identifier is associated with a local switch, and wherein the switch is a member of the fabric switch; and
a second table comprising a second mapping between the first edge identifier and a media access control (MAC) address of a local device; and
an encapsulation module adapted to encapsulate a packet in a fabric encapsulation with the first edge identifier as ingress switch identifier of an encapsulation header, wherein the fabric encapsulation is associated with the fabric switch.

2. The apparatus of claim 1, wherein the first table is stored in a respective member switch of the fabric switch.

3. The apparatus of claim 1, further comprising a learning module adapted to update the second table with a third mapping between a second edge identifier and a second MAC address of a second device, wherein the second edge identifier is associated with a remote second edge adaptor module, and wherein the second device is local to the second edge adaptor module.

4. The apparatus of claim 3, wherein the update to the second table is in response to one of:
identifying the third mapping in a notification message from the second edge adaptor module; and
identifying the second edge identifier as an ingress switch identifier in a fabric encapsulation header, and identifying the second MAC address as a source MAC address in an inner packet.

5. The apparatus of claim 1, further comprising a forwarding module adapted to:
identify the switch identifier from the first mapping in the first table based on the first edge identifier; and
identify a MAC address of the switch associated with the switch identifier; and
wherein the encapsulation module is further adapted to set the MAC address of the switch as a next-hop MAC address for the packet.

6. The apparatus of claim 1, further comprising an identifier module adapted to assign the edge identifier to the edge adaptor module in response to obtaining the edge identifier from the switch.

7. The apparatus of claim 1, wherein the apparatus is a Network Interface Card (NIC).

8. A switch, comprising:
a fabric switch module adapted to maintain a membership in a fabric switch, wherein the fabric switch includes a plurality of switches and operates as a single switch;
a storage device adapted to store a first table comprising a first mapping between a first edge identifier and a switch identifier, wherein the first edge identifier is associated with a local fabric edge adaptor, and wherein the switch identifier is associated with a second switch; and
a forwarding module adapted to, in response to identifying the first edge identifier as an egress switch identifier in a packet, identify an egress port for the packet, wherein the egress port is associated with a shortest path to the second switch.

9. The switch of claim 8, wherein the fabric switch module is further adapted to allocate the first edge identifier to the fabric edge adaptor.

10. An method, comprising:
maintaining a membership in a fabric switch, wherein the fabric switch includes a plurality of switches and operates as a single switch;
storing in a storage device a first table comprising a first mapping between a first edge identifier and a switch identifier, wherein the first edge identifier is associated with an fabric edge adaptor, wherein the switch identifier is associated with a local switch, and wherein the switch is a member of the fabric switch;
storing in the storage device a second table comprising a second mapping between the first edge identifier and a media access control (MAC) address of a local device; and
encapsulating a packet in a fabric encapsulation with the first edge identifier as ingress switch identifier of encapsulation header, wherein the fabric encapsulation is associated with the fabric switch.

11. The method of claim 10, wherein the first table is stored in a respective member switch of the fabric switch.

12. The method of claim 10, further comprising updating the second table with a third mapping between a second edge identifier and a second MAC address of a second device, wherein the second edge identifier is associated with a remote second fabric edge adaptor, and wherein the second device is local to the second fabric edge adaptor.

13. The method of claim 12, wherein the update to the second table is in response to one of:
identifying the third mapping in a notification message from the second fabric edge adaptor; and
identifying the second edge identifier as an ingress switch identifier in a fabric encapsulation header, and identifying the second MAC address as a source MAC address in an inner packet.

14. The method of claim 10, further comprising:
identifying the switch identifier from the first mapping in the first table based on the first edge identifier;
identifying a MAC address of the switch associated with the switch identifier; and
setting the MAC address of the switch as a next-hop MAC address for the packet.

15. The method of claim 10, further comprising assigning the edge identifier to the fabric edge adaptor in response to obtaining the edge identifier from the switch.

16. The method of claim 10, wherein the fabric edge adaptor is a virtual module capable of operating as a switch and encapsulating a packet from a local device in a fabric encapsulation.

17. A non-transitory computer-readable storage medium storing instructions that when executed by a computer cause the computer to perform a method, the method comprising:
maintaining a membership in a fabric switch, wherein the fabric switch includes a plurality of switches and operates as a single switch;
storing in a storage device a first table comprising a first mapping between a first edge identifier and a switch identifier, wherein the first edge identifier is associated with an fabric edge adaptor, wherein the switch identifier is associated with a local switch, and wherein the switch is a member of the fabric switch;
storing in the storage device a second table comprising a second mapping between the first edge identifier and a media access control (MAC) address of a local device; and
encapsulating a packet in a fabric encapsulation with the first edge identifier as ingress switch identifier of encapsulation header, wherein the fabric encapsulation is associated with the fabric switch.

18. The non-transitory computer-readable storage medium of claim 17, wherein the first table is stored in a respective member switch of the fabric switch.

19. The non-transitory computer-readable storage medium of claim 17, wherein the method further comprises updating the second table with a third mapping between a second edge identifier and a second MAC address of a second device, wherein the second edge identifier is associated with a remote second fabric edge adaptor, and wherein the second device is local to the second fabric edge adaptor.

20. The non-transitory computer-readable storage medium of claim 19, wherein the update to the second table is in response to one of:
identifying the third mapping in a notification message from the second fabric edge adaptor; and
identifying the second edge identifier as an ingress switch identifier in a fabric encapsulation header, and identifying the second MAC address as a source MAC address in an inner packet.

21. The non-transitory computer-readable storage medium of claim 17, wherein the method further comprises:
identifying the switch identifier from the first mapping in the first table based on the first edge identifier;
identifying a MAC address of the switch associated with the switch identifier; and
setting the MAC address of the switch as a next-hop MAC address for the packet.

22. The non-transitory computer-readable storage medium of claim 17, wherein the method further comprises assigning the edge identifier to the fabric edge adaptor in response to obtaining the edge identifier from the switch.

23. The non-transitory computer-readable storage medium of claim 17, wherein the fabric edge adaptor is a virtual module capable of operating as a switch and encapsulating a packet from a local device in a fabric encapsulation.
